(19) United States
(12) Patent Application Publication
(10) Pub. No.: US 2014/0026947 A1
(43) Pub. Date: Jan. 30, 2014

(54) VERTICAL ELECTRIC CONNECTION OF PHOTOELECTROCHEMICAL CELLS

(71) Applicants: Fabrizio Giordano, Roma (IT); Emanuele Sebastiani, Roma (IT); Thomas Meredith Brown, Roma (IT); Andrea Reale, Roma (IT)

(72) Inventors: Fabrizio Giordano, Roma (IT); Emanuele Sebastiani, Roma (IT); Thomas Meredith Brown, Roma (IT); Andrea Reale, Roma (IT)

(21) Appl. No.: 13/981,600

(22) PCT Filed: Jan. 31, 2012
(86) PCT No.: PCT/IT12/00030

§ 371 Date: Oct. 10, 2013

(30) Foreign Application Priority Data
Jan. 31, 2011 (IT) RM2011A000040

(51) Int. Cl. H01G 9/20

(52) U.S. Cl. CPC H01G 9/2081
USPC 136/251

(57) ABSTRACT

A vertical electric connection of photoelectrochemical cells is described. a conductive wire, electrically connecting a conductive coating of two substrates, arranged between the two substrates according to a zigzag configuration, bends of which alternately touch first the conductive coating of a first substrate, then the conductive coating of the other substrate.

The present invention relates to vertical electric connection of photoelectrochemical cells or DSSC (dye-sensitized solar cells).

More specifically, the invention relates to the structure of said vertical electric connections, integrated into photovoltaic modules of DSSC cells, and a process for the realisation thereof.

DSSC cells are photovoltaic cells made of a multilayered structure supported by a substrate or, more often, delimited by two substrates. Typically, said substrates are made of transparent materials (preferably glass, but also PET or PEN) and are coated, on the side facing towards the interior of the multilayered structure, by a transparent electrically conductive coating (generally a transparent conductive oxide, preferably a fluorine-doped tin oxide or an alloy of tin oxide and indium oxide, respectively FTO and ITO).

Between the two substrates one or more photoelectrochemical cells are arranged, electrically connected to one another in series and/or in parallel, each cell being made of a photo-electrode (the anode), arranged on the conductive coating of one of the two substrates; a counter-electrode (the cathode), arranged on the conductive coating of the other substrate; and an elecrolyte interpoed betweeen said photo-electrode and said counter-electrode. In particular, the photo-electrode is generally made up of a high band gap porous semi-conductive material, such as for example titanium oxide or zinc oxide, supporting the active material, made of a dye which is able to transfer electrons as a consequence of the absorption of a photon. The counter-electrode is generally made of platinum, whereas the electrolytic solution is generally based on iodine (I₂) and litium iodide (LiI).

Photoelectrochemical cells of this kind are disclosed for example in U.S. Pat. No. 4,927,721; the materials that can be used in this kind of cells are disclosed for example in U.S. Pat. No. 5,350,644.

Because of their nature, the conductive coatings of the structures have high resistance. Moreover, single cells of this kind are not able to generate the level of tension required in most possible applications to which a photoelectrochemical cell can be dedicated.

To overcome these drawbacks it is therefore necessary to connect a plurality of photoelectrochemical cells in series, with the aim of generating higher differences of tension by minimizing the whole current, i.e. minimizing power losses due to the resistance of the conductive coatings.

Practically, a photo-electrochemical module is obtained over the same substrate, i.e. a plurality of side by side photoelectrochemical cells are made, connected in series by means of a connection integrated on the same substrate, made during the making of the module.

Connections in series integrated on the substrate can be made according to different schemes, known as Z connection, W connection and external connection).

Z type connections are made of a series of vertical contacts connecting to one another electrically insulated areas of the conductive coatings of both substrates, according to a configuration that will be explained in better detail in the description below.

W type connections are obtained with no need of contacts, but the configuration of the derived photoelectrochemical module tends to have internal power imbalances, because half of the cells within a module having this configuration is illuminated on the part of the counter electrode. Additionally, on the same substrate photo-electrode and counter-electrode alternate: titanium dioxide and platinum therefore, are deposited and sintered at the same time. This implies that it is impossibile to optimize singularly the sintering process of the two materials, normally having different optimal coking time and temperature (about 420° C. and 15 minutes for the platinum precursor (usually a solution and paste containing hexachloroplatinic acid); about 500° C. and 30 minutes for titanium dioxide).

As far as the external connection is concerned, on the contrary, the long path the electrons must pass through to exit from the sides of the module, where the connection of single cells occurs, limits the length of the cells (to avoid the addition of further losses due to resistances) and greatly influence the module fill factor, a characteristic parameter describing the ratio between the maximum power produced by the device and the product of the open circuit voltage for the current loop, and decreasing proportionally with the increasing of the resistance due to the connections between cells and the resistance of loss due to the long run of electrons.

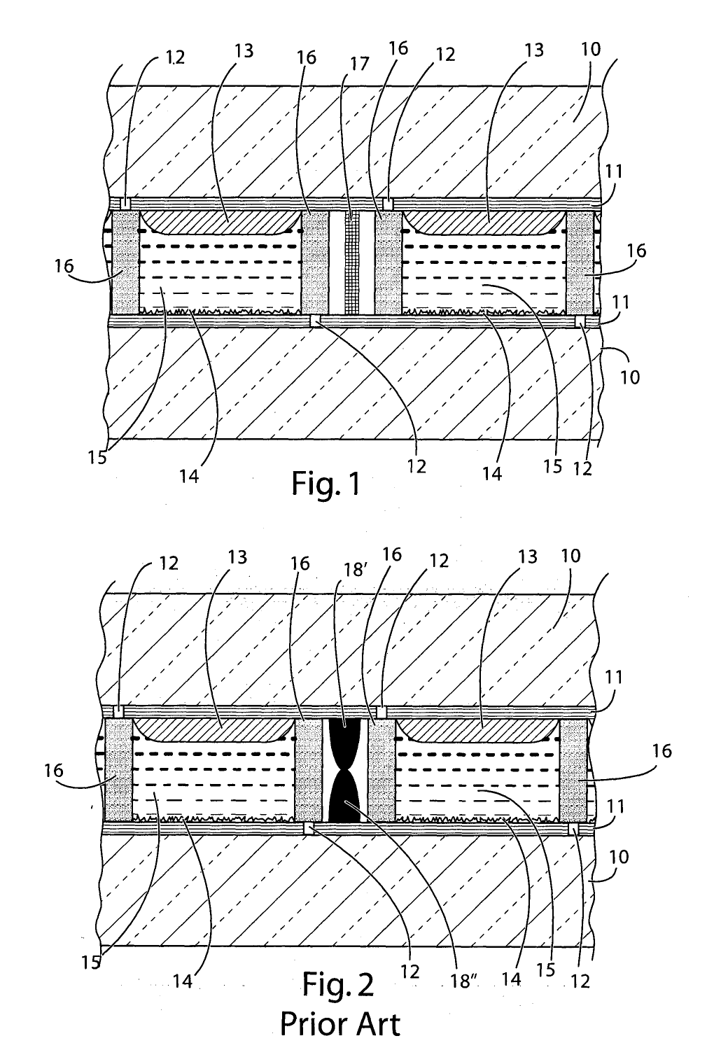

With reference to FIG. 1, is is schematically shown the configuration of a Z type connection between two cells of a photo-electrochemical module.

In particular, FIG. 1 shows two substrates, referred to with the numeral 10, internally coated by an electrically conductive transparent coating 11. The coating 11 is divided into electrically insulented regions by means of the interruptions 12. Each photoelectrochemical cell is composed of two electrically insulated regions of the conductive coatings of the two opposed substrates, each cell being made of a photo-electrode 13, arranged on the conductive coating 11 of one of the two substrates 10; a counter-electrode 14, arranged on the conductive coating 11 of the other substrate 10; and a liquid electrolyte interposed between said photo-electrode 13 and said counter-electrode 14.

Each cell is laterally limited by an incapsulant 16, the function of which is that of keeping the liquid electrolyte within the cell.

The connection in series between the two cells is obtained by jeans of the connecting element 17.

The connection path achieved through the vertical contact can be represented by three resistances: a first resistance constituted by the resistance of contact between the coating 11 arranged on the first substrate and the connecting element 17, a second resistance constituted by the resistance of the material of the connecting element 17 itself and a third resistance constituted by the resistance of contact between the connecting element 17 and the coating 11 arranged on the substrate 10 opposed to the first.

According to the prior art, the connecting element can be made through different technologies:
deposition of a conductive paste on the coating of both supports and sintering the same paste before coupling the supports to make the photoelectrochemical module (encapsulation);
deposition of a conductive paste on the coating of a single support and sintering the same before coupling the supports to make the photoelectrochemical module (encapsulation); or
deposition of a conductive paste (on the coating of one or both substrates) and curing the same during the sealing step of the photoelectrochemical module.

In all these cases, the deposition occurs by making a “track” of material on the support coating, in a position on the side of the lines of interruption of the conductive coating, so that, coupling the supports to make the photoelectrochemical module, the lines of interruption are slightly staggered between one another, allowing the conductive elements constituting the vertical contact to connect the coating of the insulated regions of opposed substrates to each other.

In case of deposition of a conductive paste on both supports and subsequent sintering before encapsulation, shown at FIG. 2, conduction occurs because of the simple mechanical contact of the two portions 18′ and 18″ of the connecting element deposited on the coating 11 of the opposed supports 10, with the consequence that the resistance between the two portions 18′ and 18″ constituting the connecting element is not negligible, whereas on the contrary the resistance between the conductive coating 11 on each substrate 10 and the respective portion 18′, 18″ of the connecting elements is negligible.

In the case of deposition of the conductive paste on a single support and sintering the same before encapsulation, conduction is caused because of a simple mechanical contact and the resistance between the coating of the substrate on which no paste was deposited and the connecting element is not negligible.

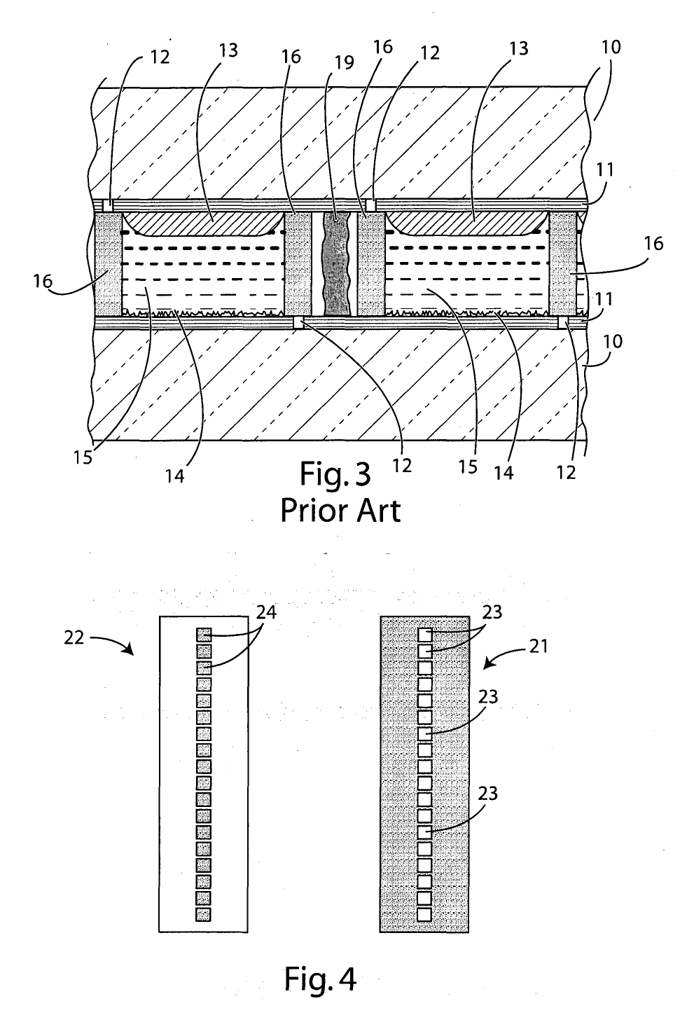

FIG. 3 shows the case of deposition of a conductive paste (on the coating 11 of one or both substrates 10) and subsequent curing of the conductive paste during the sealing step of the module, so that contact is obtained by means of a connecting element 19 made of a single body connecting the coating 11 of the two opposed substrates 10 and also chemically bound to the material of the conductive coating 11. In this case, however, the resistance generated on both sides between the conductive coating 11 and the connecting element 19 are not negligible.

The so made connections additionally have problems of electrical conduction due to the increasing of the temperature. This is due to the different thermal behaviour between the material constituting the connecting element and the material of incapsulant 16 keeping the liquid electrolyte 15 inside the respective cells.

Additionally, connections of this kind have non optimal values of conductivity (i.e. the metal pastes have smaller conductivity than bulk metal), beside the problem of the deterioration of their performance while increasing temperature.

Additionally, connections of this kind are extremely visible(generally they are 0,5 mm large or more), with consequent obvious problems of visual impact and shading in a possible application as glass window structure.

In the light of the above, it is evident the need for a vertical electric connection of photoeledtrochemical cells allowing for improving performances of the vertical contact and increasing the reliability of the connection in response of thermal mechanical stresses, and further increasing the transparence having the contact thickness reduced down to the order of 50 μm.

In this context it is proposed the solution according to the present invention, with the aim of providing vertical contacts which are resistant to thermal and mechanical stresses and highly transparent.

These and other results are achieved according to the present invention by proposing a vertical electric connection of photoelectrochemical cells made with conductive wires the dimension of which is in the order of tenth of micrometers (up to hundreds of micrometers). In practice, in order to realise the vertical connection, a solid conductive body is rolled directly in the module. The problem of this kind of connection is its extreme sensibility to thermal extensions of the incapsulant (generally a thermoplastic or silicon).

The proposed solution aims at improving the performance of the device in response to thermal stresses, in this way masking the use of micrometric wires as vertical electrical connecting element functionally possible from an electric point of view in addition to, evidently an aesthaetical point of view. A purpose of the present invention is therefore that of realising a vertical electric connection of photoelectrochemical cells allowing for overcoming the limits of the solutions according to the prior art and di achieving the previously described technical results.

Further aim of the invention is that said connecting element can be produced with substantially low costs.

Not last aim of the invention is that of obtaining a connecting element being substantially simple, safe and reliable.

It is therefore a first specific object of the present invention a vertical electric connection of photoelectrochemical cells, of the kind made of a multilayered structure delimited by two substrates that are coated, on the side facing towards the other substrate, by a conductive coating, and comprising a plurality of photoelectrochemical cells delimited by one or more structures of incapsulant material, said vertical electric connection comprising a conductive wire arranged between said two substrates, electrically connecting the conductive coating of the two substrates, said conductive wire being arranged between said two substrates according to a zigzag configuration, the bends of which alternately touch first the conductive coating of a first substrate, then the conductive coating of the other substrate.

Moreover, according to the invention said conductive wire arranged between said two substrates according to a zigzag configuration is surrounded by said encapsulation structures.

Still according to the invention, said encapsulation structures are made partly on a first substrate and partly on the other substrate and are geometrically complementary to each other.

Always according to the present invention, said conductive wire is made of a material having preferably a resistivity lower than 8·10⁻⁵ Ohm·cm, una Tensile Strength Yield higher than 10 MPa (more preferably higher than 500 MPa), a Tensile Strength Ultimate higher than 100 MPa (more preferably higher than 700 MPa).

Finally, according to the invention, said conductive wire is preferably made of a material selected amongst: tungsten, aluminium alloys, inox steel alloys.

The present invention will be described in the following, for illustrative, non limitative purpose, according to some preferred embodiments, with reference in particular to the figures, of the enclosed drawings, wherein:

FIG. 1 shematically shows a transversally sectional view of the Z-type connection configuration between two cells of a photo-electrochemical module,

FIG. 2 shematically shows a transversally sectional view of a first Z-type connection configuration between two cells of a photo-electrochemical module according to the prior art,

FIG. 3 shematically shows a transversally sectional view of a second Z-type connection configuration between two cells of a photo-electrochemical module according to the prior art,

FIG. 4 shows a top view of two complementary structures of incapsulant, comprised between two cells arranged side by side and connected in series to one another by means of a Z-type vertical electric connection, according to a first embodiment of the present invention;

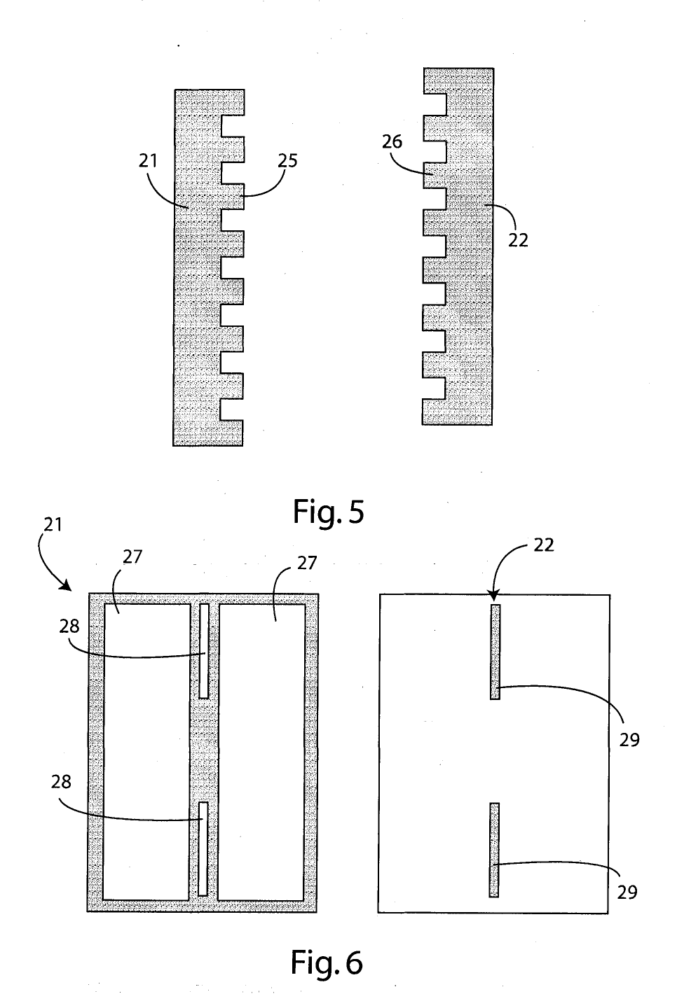

FIG. 5 shows a, top view of two complementary structures of incapsulant, comprised between two cells arranged side by side and connected in series to one another by means of a Z-type vertical electric connection, according to a second embodiment of the present invention;

FIG. 6 shows a top view of two complementary structures of incapsulant of a module of two photoelectrochemical cells arranged side by side and connected in series to one another by means of a Z-type vertical electric connection, according to a third embodiment of the present invention;

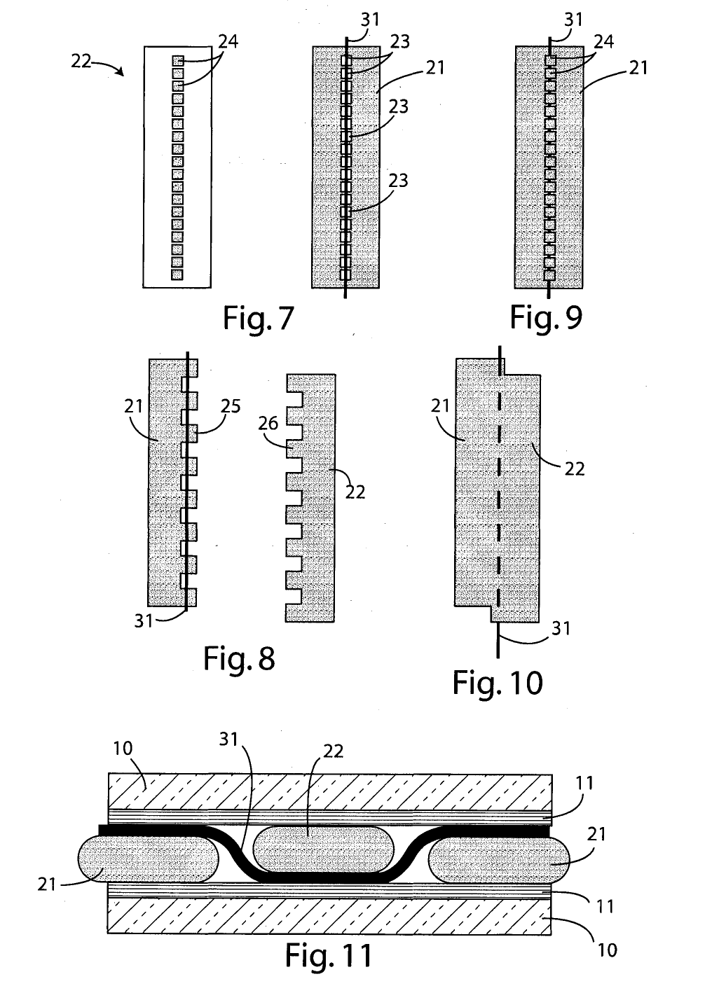

FIG. 7 shows a top view of the two complementary structures of incapsulant of FIG. 4, on one of which a wire of conductive material is arranged;

FIG. 8 shows a top view of the two complementary structures of incapsulant of FIG. 5, on one of which a wire of conductive material is arranged;

FIG. 9 shows a top view of the two complementary structures of incapsulant and of the wire of conductive material of FIG. 7, after sealing of the module;

FIG. 10 shows a top view of the two complementary structures of incapsulant and of the wire of conductive material of FIG. 8, after sealing of the module;

FIG. 11 shows a transversally sectional view of the two complementary structures of incapsulant and of the wire of conductive material of FIG. 10;

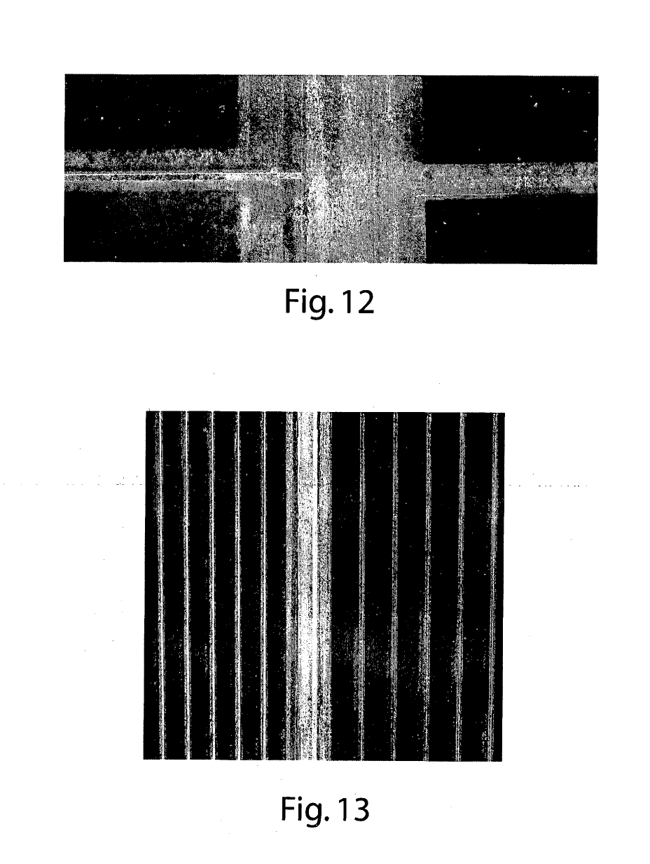

FIG. 12 shows a first comparative photographic picture of a portion of a module made according to the present invention (on the right) and of a portion of a module made according to the prior art (on the left);

FIG. 13 shows a second comparative photographic picture of a portion of a module made according to the present invention (on the right) and of a portion of a module made according to the prior art (on the left);

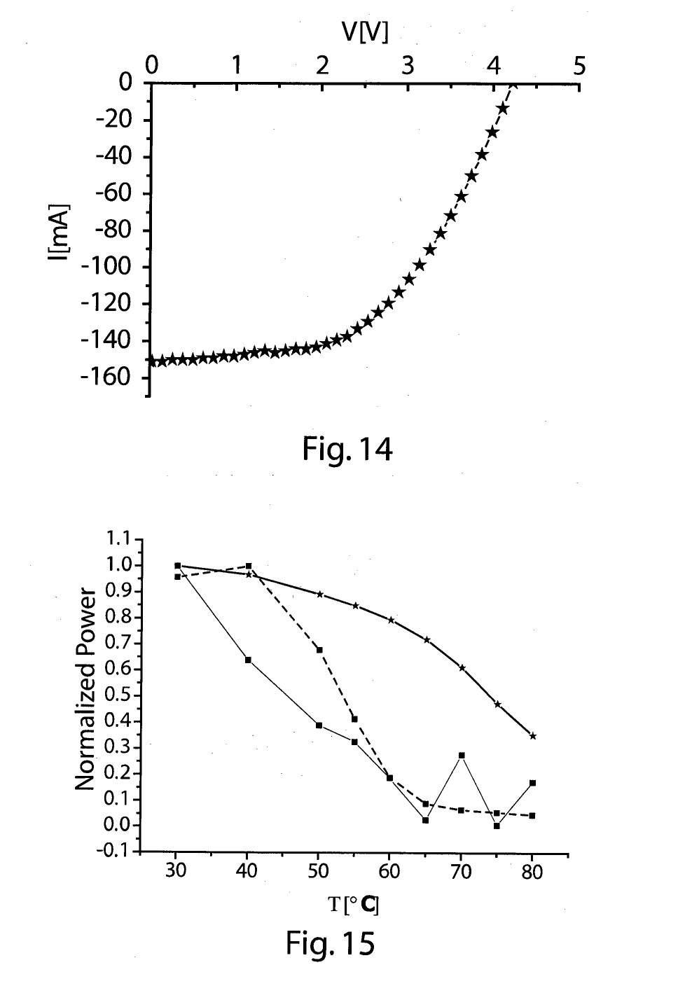

FIG. 14 shows a diagram showing the electric performance (I/V) of a module made according to the present invention; and

FIG. 15 shows a diagram showing the variation of power with temperature, respectively for a module made according to the present invention (upper curve, with star signs) and for two modules wherein the connection is made by using micrometric wires but encapsulation is standard (lower curves).

With reference to FIGS. 4, 5 and 6, wherein as an example the structures relative to the area of incapsulant comprised between two cells arranged side by side and connected in series to one another by means of a Z-type vertical electric connection are shown, in particular made according to preferred embodiments of the present invention, in order to obtain the connecting element according to the present invention two complementary cogging structures of incapsulant are preliminarily printed on the two supports that will be coupled afterwards, by screen-printing, ink jet printing or dispensing or deposited by rolling, respectively a first encapsulation structure 21 and a second encapsulation structure 22.

In particular, FIG. 4 shows a first encapsulation structure 21 having a shape substantially rectangular and provided with a plurality of empty areas 23 having the shape of a square and a second encapsulation structure 22 made of a plurality of protrusions 24 having the shape of a square suitable to match with said empty areas 23 of said first encapsulation structure 21.

FIG. 5 shows on the contrary a first encapsulation structure 21 having a shape substantially rectangular and with a side (intended for vertical electrical connection) shaped with a first crenelation 25, together with a second encapsulation structure 22, in its turn having a shape substantially rectangular and with a side (intended for vertical electrical connection) shaped with a second crenelation 26 complementary to said first crenelation 25.

FIG. 6 shows a first encapsulation structure 21 and a second encapsulation structure 22 not only with reference to the area of incapsulant comprised between two cells 27 arranged side by side and connected in series to one another by means of a Z-type vertical electric connection, but also with reference to the area surrounding said two cells 27. In particular, the first encapsulation structure 21, pertinent to the area of incapsulant comprised between the two cells 27 arranged side by side has a substantially rectangular shape and is provided with two (but they could be more) empty areas 28 with a rectangular shape, whereas the second encapsulation structure 22 is made of a corresponding number of protrusions 29 with a rectangular shape suitable to match with said empty areas 28 of said first encapsulation structure 21.

With reference to FIGS. 7 and 8, after printing on the two supports that will be coupled the two complementary cogging structures of incapsulant, respectively a first encapsulation structure 21 and a second encapsulation structure 22, on one of the two encapsulation structures, in correspondence of the complementary shapes intended for cogging (in particular, with reference to FIG. 7, in correspondence of empty areas 23 and with reference to FIG. 8, in correspondence of the first crenelation 25), is aligned a wire 31 made of a conductive material, having a diameter equal to 50-100 μm (suitably dimensioned in consideration of the thickness of the chamber of the cell).

Material which are particularly suitable for making the wire 31 are conductive materials (with a resistivity preferably lower than 6·10⁻⁶ Ohm·cm) having mechanical features making them suitable to resist the stresses to which they could be subjected as a consequence of the thermal dilatation of the incapsulant material or of the stress due to the process of sealing of the module. In particular, a suitable material should have characteristics of Tensile Strength Yield preferably upper than 10 MPa (and more preferably upper than 500 MPa) and characteristics of Tensile Strength Ultimate preferably upper than 100 MPa (and more preferably upper than 700 MPa).

Particularly suitable for producing the wire 31 made of a conductive material are: tungsten, aluminium alloys and inox steel alloys. Materials such as titanium, copper, gold, silver, aluminium and other metals and or alloys are also suitable.

Afterwards, as shown with reference to FIGS. 9 and 10, the two substrates on which the two complementary cogging structures of incapsulant were printed are coupled, thus sealing the module, forcing the wire 31 to take a zigzag configuration between the surface of an electrode and that of the other, making the vertical connection. In this connection, FIG. 11, showing a transversally sectional view of the module obtained by coupling the two substrates 10, with conductive coating 11 and complementary structures of incapsulant 21 and 22, allows to visualise the path of the wire 31 made of a conductive material, running along the thickness between the two facing layers of conductive coating 11 with a zigzag path, delimited by two complementary structures of incapsulant 21 and 22.

From what was previously described, it is evident that the making of contacts is framed in the process of encapsulation of the module. The layout of the incapsulant is thus conceived and suitably designed, resulting to be necessarily different from the solutions according to the prior art.

With reference to the process of making the contact, the procedure provides for the application of complementary structures of incapsulant 21, 22 on the conductive coating 11 of both substrates 10. As already seen with reference to the description of FIGS. 4-10, and in particular as shown with reference to FIG. 6, such structures of incapsulant 21, 22 are made within the space comprised between two cells 27 arranged side by side to be electrically connected in series.

Subsequently, a conductive wire 31 is drawn from a coil on one of the two structures of incapsulant 21, 22. Then, the two substrates 10 are coupled together as a sandwich and the formed module is sealed by pressure and temperature. At this point, the wire 31 is cut by means of a device that, beside cutting, holds the end of the wire 31, keeping it ready for the subsequent application. This is made in parallel per each contact of the module.

The so realised structure is therefore completely enclosed in the incapsulant.

Making reference again to FIG. 11, the merit of such a configuration is evident. In fact, under the hypothesis of a thermal expansion of the incapsulant 21, 22, the wire 31 is pressed, further improving the contact with the conductive layer 11 coating the two substrates 10.

### Example of Production

As a practical example the production of DSSC modules is reported.

In particular, a module DSSC with cells arranged in series by means of Z-type vertical contacts was made with a wire of tungsten according to the embodiment of the present invention shown with reference to FIG. 6 and its characteristics were compared with those of a DSSC module of the same kind made according to the prior art, as far as, an aesthaetical comparison is concerned, and with two DSSC modules of the same kind made respectively with a wire of tungsten and with a gold wire and with a structure of incapsulant made according to the prior art as far as a comparison on performances is concerned.

In all cases, as incapsulant material a thermoplastic material (Dupont Surlyn 1702) was used having a thickness equal to 50 μm, whereas the used wires were made of tungsten, with a diameter equal to 50 μm, for the module made according to the present invention and tungsten, having a diameter equal to 50 μm, or made of gold, with a diameter equal to 50 μm, respectively for the two embodiments made, for comparative purposes, with a structure of incapsulant made according to the prior art.

In details, the steps of the process of making vertical contacts according to the present invention were the followings:
pre-rolling of a first structure of incapsulant 21 on the coating layer 11 of a first substrate 10, on the side of the photo-electrode;
pre-rolling of the complementary structure of incapsulant on the coating layer 11 of a second substrate 10, on the side of the counter-electrode;
application of the conductive wire 31 on the structure of incapsulant 21 on the coating layer 11 of said first substrate 10, on the side of the photo-electrode; and
coupling and sealing of the two multilayer structures which are made of substrate, conductive coating and structure of incapsulant.

With reference to FIG. 12, it is immediately evident that the advantages of the solution according to the present invention are mainly of aesthaetical kind. In fact, the module made according to the prior art, by means of deposition through screen printing of the vertical contact, shown on the left of FIG. 12, has a visual impact much greater than the module made with a microwave conductive wire according to the present invention, on the right in the picture. It is an evident consequence a correspondent difference of shading in a possible application of the module as a glass window structure.

With reference to FIG. 13, it is shown how the use of wires of tungsten having micrometric size allows for an easier reduction of the interdistance between the cells. In fact, whereas the portion of module made according to the prior art with printed contacts and shown on the left in the photographic picture has an interdistance of 3 mm, the portion of the module made according to the present invention with contacts having wires of tungsten and shown on the right in the photographic picture has an interdistance of 2 mm, thus implying a better effect of uniformity.

In this example it was chosen to realise a module giving preference to the aesthaetical impact with the criterium of uniformity rather than performance. Consequently, it is licit to expect performance can be surely improved, for example through the optimization of the cell geometry and the number of meanders of the connection. Nevertheless, modules realised according to the present invention reach anyway an efficiency of 3% on the active area (2.6% of the total area).

The electric performance of a prototype with a connection made with wires arranged as meanders according to the present invention is shown with reference to FIG. 14. The characteristics of the module made according to the prior art can be summarised as follow:
kind of connection: Z
total area: 139 cm²
active area: 122 cm²
AR (Aperture Ratio: Ratio between Active area and total area of the module)=87.8%
test conditions: indoor with irradiation equal to 900 W/m²RT
n over the active area: 3%
over the total area: 2.6%
Pₘₐₓ=330 mW con Vₘₐₓ=2.7V and Iₘₐₓ=−124 mA

As already said, the module made according to the present invention was further compared with two different modules respectively made with a wire of tungsten and with a gold wire and with a structure of incapsulant made in both cases according to the prior art, to put under evidence the thermal characteristic introduced by the proposed structure with respect to a standard encapsulation technique.

It is believed that the proposed ondulatory structure is much stronger, since the thermal expansion of the incapsulant helps the connection between conductive wire and conductive coating, which does not happen in the traditional structure.

In particular, FIG. 15 shows a diagram showing the variation of power of a module made according to the present invention (upper curve, with star signs) and of two modules wherein the connection is made by means of micrometric wires but encapsulation is standard (lower curves), according to the increase of temperature (and of the consequent thermal expansion of the incapsulant). In particular, the module according to the present invention is made of micrometric wires of tungsten, whereas the two modules wherein the encapsulation is made according to the prior art are respectively made of micrometric wires of tungsten (dashed curve with square signs) and of gold (continuous curve with square signs). It is immediately evident that the encapsulation structure according to the present invention allows for achieving a smaller reduction of the power when the temperature varies than the comparative solutions.

The present invention has been described for illustrative, non limitative purpose, according to its preferred embodiments, but it must be understood that variations and/or modifications can be made by the skilled in the art without escaping the relative scope of protection, as defined by the enclosed claims.

1. A vertical electric connection of photoelectrochemical cells, of a kind made of a multilayered structure delimited by two substrates that are coated, on a side facing towards the other substrate, by a conductive coating, and comprising a plurality of photoelectrochemical cells delimited by one or more structures of incapsulant material, the vertical electric connection comprising a conductive wire, electrically connecting the conductive coating of the two substrates and arranged between said two substrates according to a zigzag configuration, wherein bends of the zigzag configuration alternately touch first the conductive coating of a first substrate, then the conductive coating of the other substrate.

2. The vertical electric connection according to claim 1, wherein said conductive wire arranged between said two substrates according to a zigzag configuration is surrounded by said encapsulation structures.

3. The vertical electric connection according to claim 1, wherein said encapsulation structures are made partly on a first substrate and partly on the other substrate and are geometrically complementary to each other.

4. The vertical electric connection according to claim 1, wherein said conductive wire is made of a material having a resistivity lower than 8·10⁻⁵ Ohm·cm.

5. The vertical electric connection according to claim 1, wherein said conductive wire is made of a material having a Tensile Strength Yield higher than 10 Pa.

6. The vertical electric connection according to claim 5, wherein said conductive wire is made of a material having a Tensile Strength Yield higher than 500 MPa.

7. The vertical electric connection according to claim 1, wherein said conductive wire is made of a material having a Tensile Strength Ultimate higher than 100 MPa.

8. The vertical electric connection according to claim 7, wherein said conductive wire is made of a material having a Tensile Strength Ultimate higher than 700 MPa.

9. The vertical electric connection according to claim 1, wherein said conductive wire is made of a material selected amongst: tungsten, aluminium alloys, inox steel alloys.
